(19) United States
(12) Patent Application Publication
(10) Pub. No.: US 2016/0234037 A1
(43) Pub. Date: Aug. 11, 2016

(54) COMMUNICATION SYSTEM AND COMMUNICATION METHOD

(71) Applicant: TOYOTA JIDOSHA KABUSHIKI KAISHA, Toyota-shi, Aichi-Ken (JP)

(72) Inventor: Mitsuhiro MABUCHI, Shinagawa-ku, Tokyo (JP)

(73) Assignee: TOYOTA JIDOSHA KABUSHIKI KAISHA, Toyota-shi, Aichi-ken (JP)

(21) Appl. No.: 15/029,846

(22) PCT Filed: Oct. 15, 2014
(86) PCT No.: PCT/IB2014/002327

§ 371 Date: Apr. 15, 2016

(30) Foreign Application Priority Data
Oct. 18, 2013 (JP) 2013-217001

(51) Int. Cl. H04L 12/40; H04L 25/20; H04L 12/66; H04L 29/08

(52) U.S. Cl. CPC H04L 12/40182; H04L 67/12; H04L 25/20; H04L 12/66

(57) ABSTRACT

A communication system includes: a communication device that is connected to a communication line and that performs communication via the connected communication line using a communication message including a data area in which data is stored and an identifier area in which a communication identifier determined to correspond to the data is stored; and a gateway that is connected to a plurality of the communication lines and that relays a communication message among the plurality of communication lines. The communication device transmits a communication message, in which user data and a communication identifier corresponding to the user data are stored in the data area and a relay identifier for allowing the gateway to specify a communication line through which the user data stored in the data area is transmitted in the identifier area, to the gateway.

### BACKGROUND OF THE INVENTION

1. Field of the Invention

The present invention relates to a communication system in which plural electronic control units mounted on a vehicle or the like are connected to a network and a communication method thereof.

2. Description of Related Art

Plural electronic control units (ECUs) mounted on a vehicle are often connected to a network to constitute a vehicle network system enabling the ECUs to transmit and receive information (vehicle information) thereof to and from each other. An example of a communication system constituting the vehicle network system is a controller area network (CAN).

In general, the plural ECUs connected to the network are often configured to receive all communication messages streaming in the network. Accordingly, enlargement in scale of the network increases the communication traffic volume in the network and also increases the possibility that an unnecessary outflow of information will be caused with an enlargement in the delivery coverage for communication messages. Therefore, a technique of limiting the transmission of communication messages to a necessary range or the like has been proposed (for example, Japanese Patent Application Publication No. 2010-50958 (JP 2010-50958 A).

The communication system constituted by the CAN often has a configuration in which plural communication lines (buses) are connected to each other by a gateway, that is, a so-called star configuration. In such a star-like network, a communication message transmitted through one communication line is delivered to another communication line by a relaying process of the gateway.

Recently, types of communication messages transmitted to the buses are often changed due to a change in processing details of the ECUs, a change of the ECUs connected to the communication lines, or the like. In this case, in the star-like network including the gateway, it is necessary to review the relaying process of a communication message in the gateway so as to cope with the change in the types of the communication messages transmitted via the buses and thus the versatility as a network may be limited.

### SUMMARY OF THE INVENTION

The invention provides a communication system that can enhance versatility as a network including a gateway and a communication method thereof.

According to a first aspect of the invention, there is provided a communication system including: a communication device that is connected to a communication line and that performs communication via the connected communication line using a communication message including a data area in which data is stored and an identifier area in which a communication identifier determined to correspond to the data is stored; and a gateway that is connected to a plurality of the communication lines and that relays a communication message among the plurality of communication lines, wherein the communication device transmits a communication message, in which user data and a communication identifier corresponding to the user data are stored in the data area and a relay identifier for allowing the gateway to specify a communication line through which the user data stored in the data area is transmitted in the identifier area, to the gateway.

According to a second aspect of the invention, there is provided a communication method in a communication system including a communication device that is connected to a communication line and that performs communication via the connected communication line using a communication message including a data area in which data is stored and an identifier area in which a communication identifier determined to correspond to the data is stored and a gateway that is connected to a plurality of the communication lines and that relays a communication message among the plurality of communication lines. The communication method including: causing the communication device to store user data and a communication identifier corresponding to the user data in the data area of the communication message; causing the communication device to store a relay identifier for allowing the gateway to specify the communication line through which the user data stored in the data area is transmitted in the identifier area of the communication message; and causing the communication device to transmit the generated communication message to the gateway.

According to the aspects, the communication line used for transmission is specified by the gateway regardless of the type of the user data. Accordingly, it is possible to enhance versatility in transmission of a communication message as the communication system. In a controller area network (CAN) that is often used for a vehicle network system, since an identifier is determined depending on the type of the user data, it is necessary to set the communication lines as transmission destinations depending on the types of the user data, but the communication line as the transmission destination is specified regardless of the types of the user data by using the relay identifier.

In the aspect, the gateway may have information of the relay identifier and a communication line as a transmission destination corresponding to the relay identifier and the gateway may specify the communication line as the transmission destination of a communication message from which the relay identifier is acquired on the basis of the relay identifier acquired from the identifier area of the received communication message.

In the aspect, the gateway may specify the communication line as a transmission destination of the communication message from which the relay identifier is acquired on the basis of the relay identifier acquired from the identifier area of the communication message by presetting the communication line as the transmission destination corresponding to the relay identifier.

According to these configurations, the gateway can specify the communication line as the transmission destination of the communication message regardless of the type of the user data.

In the aspect, the gateway may generate a communication message in which a communication identifier stored in the data area of the communication message having the relay identifier is stored in the identifier area and user data stored in the communication message is stored in the data area, and may transmit the generated communication message to the specified communication line.

According to this configuration, a communication message to which the relay identifier is added can be generated as a communication message having, a communication identifier corresponding to the user data in the identifier area and the generated communication message is transmitted to the specified communication line by the relay identifier. Accordingly, a communication message having the relay identifier and transmitted to the gateway is transmitted as a communication message in the related art from the gateway to the communication line.

In the aspect, the communication line as a transmission source corresponding to the relay identifier may be set in the gateway and the gateway may perform a process of relaying the communication message when the communication line as the transmission source of the communication message is equal to the communication line as the transmission source corresponding to the relay identifier in the identifier area of the communication message.

A communication message having the relay identifier is relayed by the gateway regardless of the type of the user data. Therefore, according to the configuration, it is possible to suppress incorrect use of the relay identifier and to improve security of the communication system, by checking the communication line as the transmission source of the communication message having the relay identifier on the basis of the relay identifier.

In the aspect, the communication device transmitting the communication message may add security information used for proof of correctness of the communication message to the data area and may transmit the communication message, and the gateway may perform the process of relaying the communication message when it is determined that the communication message is correct on the basis of the security information.

According to this configuration, it is possible to achieve improvement in communication security using a communication message with a relay identifier relayed by the gateway regardless of the type of the user data, by checking the correctness of the communication message using security information. Known techniques such as encryption using a private key as security information may be used.

### BRIEF DESCRIPTION OF THE DRAWINGS

Features, advantages, and technical and industrial significance of exemplary embodiments of the invention will be described below with reference to the accompanying drawings, in which like numerals denote like elements, and wherein:

FIG. 1 is a block diagram schematically illustrating a configuration of a communication system according to a first embodiment of the invention;

FIG. 2 is an explanatory diagram illustrating relay IDs used for the communication system;

FIG. 3 is a diagram schematically illustrating a communication message transmitted from an ECU in the communication system;

FIG. 4 is a diagram schematically illustrating a communication message transmitted from a gateway in the communication system;

FIG. 5 is a flowchart illustrating a process flow of a relaying process in the gateway of the communication system;

FIG. 6 is a block diagram schematically illustrating a configuration of a communication system according to a second embodiment of the invention;

FIG. 7 is an explanatory diagram illustrating a process of coupling communication messages in the gateway of the communication system;

FIG. 8 is a flowchart illustrating a process flow of a relaying process in the gateway of the communication system;

FIG. 9 is, a diagram schematically illustrating a data structure of a communication message in a communication system according to a third embodiment of the invention;

FIG. 10 is a diagram schematically illustrating a data structure of a communication message in a communication system according to a fourth embodiment of the invention; and

FIG. 11 is a diagram schematically illustrating a data structure of a communication message in a communication system according to a fifth embodiment of the invention.

### DETAILED DESCRIPTION OF EMBODIMENTS

### First Embodiment

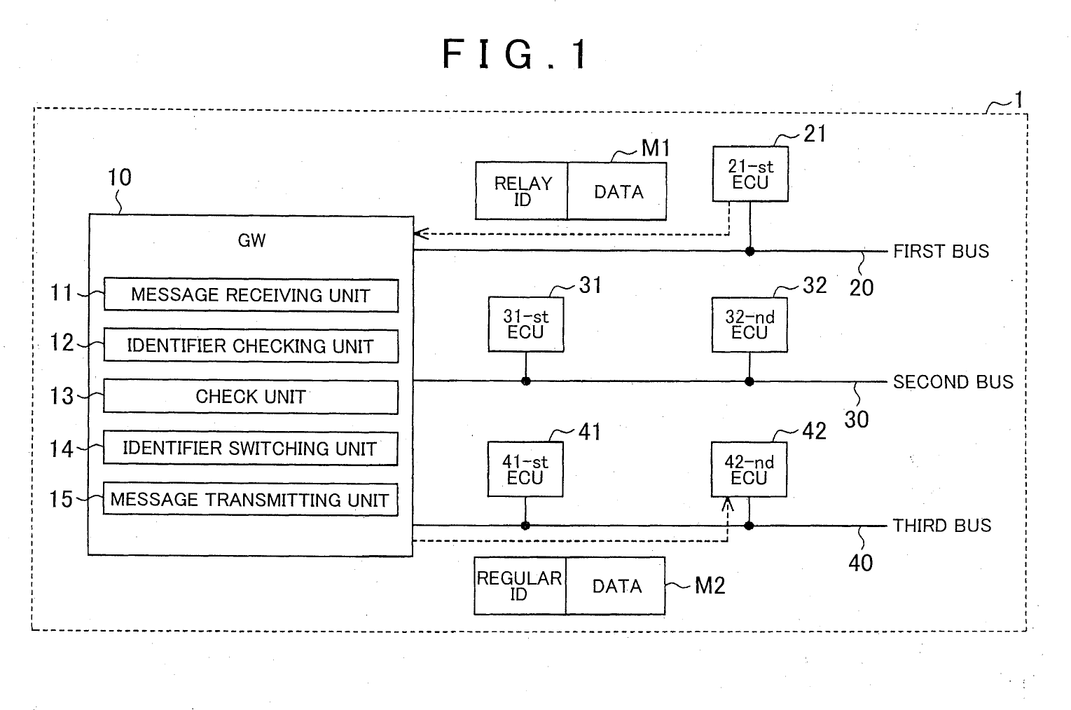

A communication system according to a first embodiment of the invention will be described below with reference to FIGS. 1 to 5. As illustrated in FIG. 1, a vehicle 1 includes a vehicle network system as a communication system.

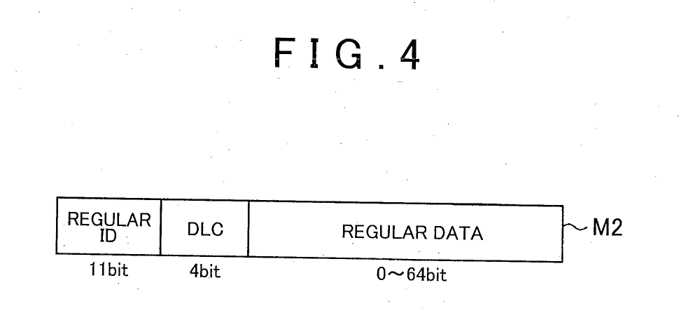

First, a communication protocol of the vehicle network system in this embodiment will be described. The vehicle network system is configured as a network to which a controller area network (CAN) protocol is applied as a communication protocol. In the CAN protocol, communications between communication devices are performed by transmitting and receiving communication messages and a communication message is constituted by a frame which is defined as a unit of communication in the CAN protocol. Plural frames are defined in the CAN protocol and include a data frame used to transmit data. For example, a data frame of a standard format includes an “identifier field” (ID field) provided with a size of 11 bits and a “data area” (data field) provided with a size in the range of 0 to 64 bits (for example, see FIG. 3 or FIG. 4). The “identifier area” is a storage area of a “message ID” (CAN ID) used to identify a communication message. In the CAN protocol, the “message ID” is determined to correspond to the types of user data stored in the data area. The “data area” is an area in which user data transmitted through the use of a communication message is stored. The user data is data that can be arbitrarily determined by a user and is data of which details are not defined by the CAN protocol or the like. The data frame includes “data length code (DLC)” provided with a size of 4 bits. The “DLC” is information with a size of 4 bits defined by the CAN protocol and is information for designating the size of the “data area”. In FIG. 3, the reason for setting the “DLC” to three bits will be described later.

In this embodiment, as illustrated in FIG. 3 or FIG. 4, the message ID corresponds to a “regular ID” or a “relay ID”. That is, the “regular ID” or the “relay ID” is a value having a size of 11 bits that can be stored in an “identifier area” of a data frame. In this embodiment, values not overlapping with each other are allocated to the “regular ID” and the “relay ID”. The user data corresponds to “regular data”. That is, the “regular data” is a value having a size in the range of 0 to 64 bits that can be stored in the “data area” of a data frame.

The configuration of the communication system according to this embodiment will be described below. As illustrated in FIG. 1, the communication system disposed in the vehicle 1 includes a gateway (GW) 10 and a first bus 20, a second bus 30, and a third bus 40 as communication lines as communication buses connected to the GW 10. The first to third buses 20, 30, and 40 are configured as buses capable of transmitting a communication message of a CAN protocol and are formed of, for example, twist pair cables. The GW 10 can relay (transmit) a communication message of the CAN protocol input from the first to third buses 20, 30, and 40 to another bus connected thereto. Accordingly, the communication system has a configuration in which the first to third buses 20, 30, and 40 are connected to each other via the GW 10, that is, a so-called star-like network configuration, and is configured as a system capable of transmitting (relaying) a communication message of the CAN protocol among the first to third buses 20, 30, and 40.

Each of the first to third buses 20, 30, and 40 is connected to one or more electronic control units (ECU) so as to communicate with another ECU via the corresponding bus. For example, the first bus 20 is connected to a 21-st ECU 21 as a communication device, the second bus 30 is connected to 31-st and 32-nd ECUs 31, 32 as communication devices, and the third bus 40 is connected to 41-st and 42-nd ECUs 41, 42 as communication devices.

The 21-st to 42-nd ECUs 21 to 42 are so-called electronic control units (ECUs) and is configured to include a microcomputer having a computation unit or a storage unit. Accordingly, the 21-st to 42-nd ECUs 21 to 42 provides a predetermined function to a control target to control the control target by reading a control program or various parameters stored in the storage unit into the computation unit and executing or processing the control program or the parameters. The 21-st to 42-nd ECUs 21 to 42 are devices used for a variety of control of the vehicle 1 and are, for example, ECUs having a driving system, a running system, a sensor system, and an information instrument system as control targets. Accordingly, the 21-st to 42-nd ECUs 21 to 42 have user data (regular data) to be transmitted to the communication system. An example of the ECU having the driving system as a control target is an engine ECU, an example of the ECU having a running system as a control target is a steering ECU or a brake ECU, and an example of the ECU of the sensor system is an ECU connected to sensors such as a temperature sensor or a speed sensor. An example of the ECU having an information instrument system as a control target is a car navigation ECU.

The 21-st to 42-nd ECUs 21 to 42 can receive a communication message from the bus connected thereto. Accordingly, plural ECUs connected to the same bus can transmit and receive information required for control by transmission and reception of a communication message via the bus connected thereto. For example, the 21-st ECU 21 can receive a communication message from the first bus 20 and the 42-nd ECU 42 can receive a communication message from the third bus 40. The 21-st to 42-nd ECUs 21 to 42 can also receive a communication message transmitted from the GW 10 connected to the bus connected thereto.

The 21-st to 42-nd ECUs 21 to 42 can transmit a communication message to the bus connected thereto. In the 21-st to 42-nd ECUs 21 to 42, a “regular ID” corresponding to “regular data” as user data transmitted therefrom is set. The “regular ID” is stored in the storage unit (not illustrated) of each of the 21-st to 42-nd ECUs 21 to 42. The 21-st to 42-nd ECUs 21 to 42 can generate a communication message on the basis of the “regular data” to be transmitted and the “regular ID” corresponding to the “regular data” and can transmit the generated communication message to the bus. For example, the 21-st ECU 21 can transmit a communication message through the first bus 20, and the 42-nd ECU 42 can transmit a communication message through the third bus 40.

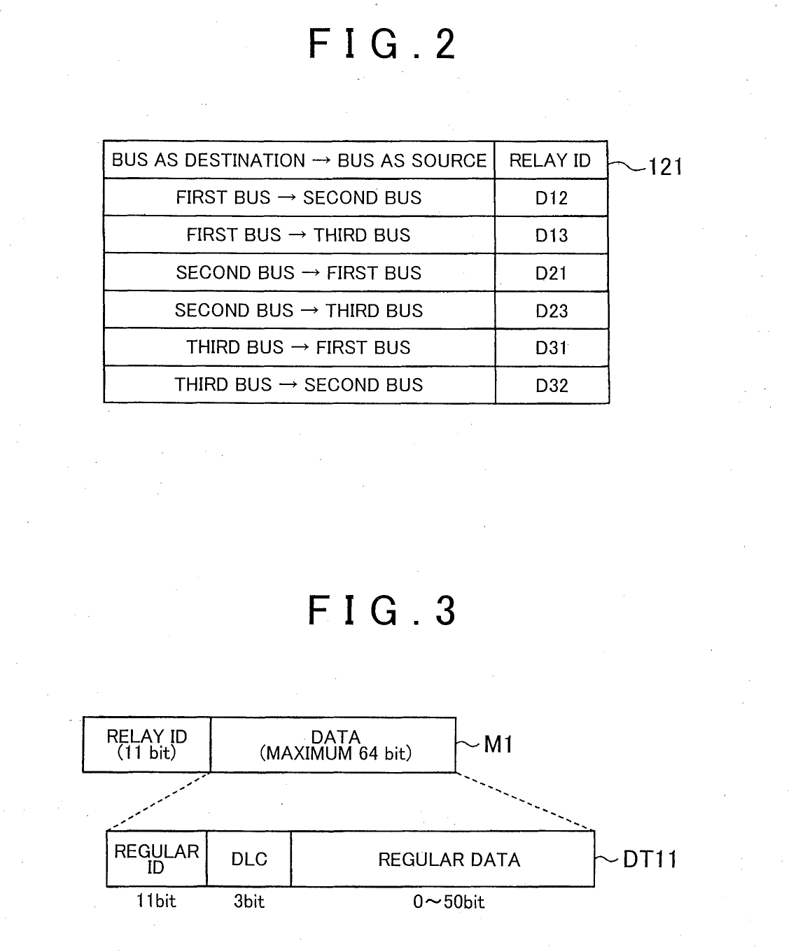

As illustrated in FIG. 2, the 21-st ECU 21 includes relay ID information 121 in which a “relay ID” is set. In the relay ID information 121, a bus as a transmission destination and a bus as a transmission source correlated with the set “relay ID” are set. The “relay ID” is an identifier for causing the GW 10 to specify a bus through which the “regular data” stored in the “data area” is transmitted. That is, the “relay ID” determines the relationship between the bus as a transmission source and the bus as a transmission destination when viewed from the GW 10, unlike the “regular ID” determined depending on details of the “regular data”. The “relay ID” is set to, for example, a value of “0x3F2h” (hexadecimal number), but for the purpose of convenience of explanation, the “relay ID” is replaced with reference sign “D12” or the like, not with a value of 11 bits, in the following description.

For example, in the relay ID information 121, “D12” is set as the “relay ID” for relaying data from the first bus to the second bus, and “D13” is set as the “relay ID” for relaying data from the first bus to the third bus. In the relay ID information 121, “D21” is set as the “relay ID” for relaying data from the second bus to the first bus, and “D23” is set as the “relay ID” for relaying data from the second bus to the third bus. In, the relay ID information 121, “D31” is set as the “relay ID” for relaying data from the third bus to the first bus, and “D32” is set as the “relay ID” for relaying data from the third bus to the second bus. In this embodiment, at least “D13” has only to be set as the “relay ID” in the relay ID information 121 of the 21-st ECU 21.

The 21-st ECU 21 can select the corresponding “relay ID” from the relay ID information 121 on the basis of the bus (bus as a transmission source) connected thereto and the bus (bus as a transmission destination) for transmitting the “regular data”.

As illustrated in FIG. 3, the 21-st ECU 21 generates “relay data DT11” including “regular data” and a communication “regular ID” corresponding to the “regular data” and stores the generated “relay data DT11” in the “data area” of a communication message M1. The 21-st ECU 21 selects a “relay ID” from the relay ID information 121 on the basis of the bus connected thereto and the bus for transmitting the “regular data” and stores the selected “relay ID” in the “identifier area” of the communication message M1. That is, the 21-st ECU 21 can generate the communication message M1 in which the “relay ID” is stored in the “identifier area” and “relay data” including the “regular data” is stored in the “data area”. For example, the 21-st ECU 21 selects “D13” as the “relay ID” on the basis of the information that the bus as a transmission source is the first bus 20 and the bus as a transmission destination is the third bus 40. The 21-st ECU 21 generates a relay communication message M1 in which “D13” is stored in the “identifier area” and the “relay data DT11” is stored in the “data area”. The total length of the “relay data DT11” is limited to 64 bits, and includes a “regular ID” of 11 bits, “DLC” of 3 bits, and “regular data” of 0 to 50 bits. At this time, user data is set as the “regular data” and a message ID corresponding to the user data is set as the “regular ID”. The “DLC” is set as information for defining the length of the “regular data”. In the CAN protocol, the “DLC” is a 4-bit length and the length of the “regular data” is set by bytes, but since the length of the “regular data” limited to 0-bit to 50-bit lengths in the relay data has a value of 0 to 6 bytes and can be expressed in a 3-bit length, the “DLC” has a value of 3 bits. That is, the communication message M1 stores the “regular ID”, the “DLC”, and the “regular data”, which are information required for generating a new communication message M2, in the “data area”.

The GW 10 is configured to include a microcomputer having a computation unit or a storage unit as a so-called electronic control unit (ECU). Accordingly, the GW 10 provides a predetermined function to a control target to control the control target by reading a control program or various parameters stored in the storage unit into the computation unit and executing or processing the control program or the parameters.

The GW 10 is a device having a configuration for outputting a communication message input from a bus to another bus, that is, a device that relays a communication message among plural buses. Accordingly, the plural buses transmit and receive a communication message via the GW 10 connected thereto. The GW 10 includes the relay ID information 121.

The GW 10 performs two types of relaying of relaying a communication message based on the “regular ID” and relaying a communication message based on the “relay ID”. In this embodiment, for the, purpose of convenience of explanation, the relay of a communication message based on the “regular ID” is referred to as “normal relay” and the relay of a communication message based on the “relay ID” is referred to as “universal relay”.

In the “normal relay”, the GW 10 specifies a bus as a transmission destination on the basis of the “regular ID” and the “regular ID information” of the communication message and specifies the specified bus as a bus for transmitting the communication message. That is, in the “normal relay”, the GW 10 can receive. (input) a communication message with the “regular ID” added thereto from the first to third buses 20, 30, Sand 40 connected thereto and relays (transmits) the received communication message to the bus determined by the “regular ID information” depending on the “regular ID” of the communication message.

For example, the GW 10 specifies the bus as a transmission destination of the communication message input from the first bus 20 to be the second and third buses 30, 40 on the basis of the “regular ID” of the communication message and outputs the input communication message to the specified second and third buses 30, 40. That is, the communication message input from the first bus 20 is relayed to the second and third buses 30, 40. In this way, a communication message is transmitted and received (given and taken) between the ECUs connected to different buses via the GW 10.

In the “universal relay”, the GW 10 specifies the bus of a transmission destination on the basis of the “relay ID” and the “relay ID information” of the communication message. The GW 10 generates a new communication message M2 from the “relay data” of the communication message and specifies the transmission destination of the generated new communication message M2 to be the bus specified on the basis of the “relay ID” and the “relay ID information”. That is, the “universal relay”, the GW 10 receives (inputs) a communication message with a “relay ID” added thereto from the first to third buses 20, 30, and 40 connected thereto. The GW 10 generates a new communication message M2 from the received communication messages and relays (transmits) the new communication message M2 to the bus determined depending on the “relay ID”. For example, the GW 10 specifies the bus of a transmission destination of the communication message M1 with the relay ID added thereto input from the first bus 20 to be the third bus 40 on the basis of the “relay ID” of the communication message M1. The GW 10 generates a new communication message M2 on the basis of the communication message M1 with the relay ID added thereto. Then, the GW 10 outputs the generated new communication message M2 to the third bus 40 specified as the transmission destination.

In general, the “regular ID” is determined depending on the type of the “regular data”. Accordingly, in the communication system, when the type of the communication message transmitted to each bus, that is, the type of the “regular data”, is changed due to change of processing details of an ECU connected thereto, change of an ECU connected to the bus, and the like, the “regular ID” to be transmitted to the bus is changed. Then, in the GW 10 relaying a communication message in a star-like network, the “regular ID information” has to be corrected so as to be suitable for the changed type of the communication message, that is, it is necessary to review the process of relaying the communication message, and thus the universality as a network is limited. On the other hand, the “relay ID” is not specified depending on the type of the “regular data” but is used to specify a bus to which the GW 10 transmits (relays) a communication message M2 newly generated from the “relay data”. Accordingly, even when the “regular ID” transmitted to the bus is changed, the GW 10 specifies the bus as a transmission destination by using the “relay ID” not depending on the type of the “regular data” and it is thus possible to enhance the universality of the relay that is performed by the GW 10.

When a communication message having a message ID not set in the “regular ID information” or the “relay ID information” is input, the GW 10 does not relay the communication message. That is, the communication message is not output from the GW 10.

Accordingly, the GW 10 transmits a communication message corresponding to the received communication message to the bus as a transmission destination specified by the “regular ID” or the “relay ID” acquired from the received communication message. For example, when the bus specified on the basis of the “regular ID” or the “relay ID” of a communication message input from the first bus 20 is the second and third buses 30, 40, the GW 10 transmits the corresponding communication message to the second and third buses 30, 40. For example, when the bus specified on the basis of the “regular ID” or the “relay ID” is the third bus 40, the GW 10 transmits the corresponding communication message to the third bus 40 and does not transmit the corresponding communication message to the second bus 30. Accordingly, the GW 10 can suppress the communication traffic volume of the entire communication system by regulating the communication message so as to be transmitted to only the bus requiring the communication message.

The configuration of the GW 10 will be described below in detail. The GW 10 includes a message receiving unit 11 that receives and processes a communication message, an identifier checking unit 12 that checks the identifier of the received communication message, and a message transmitting unit 15 that transmits a communication message to a bus. The GW 10 further includes a check unit 13 that checks the correctness of a communication message of which the identifier is checked to be the “relay ID” by the identifier checking unit 12 and an identifier switching unit 14 that generates a new communication message corresponding to the communication message with the “relay ID” added thereto.

The message receiving unit 11 receives (inputs) a communication message from the first to third buses 20, 30, and 40. The message receiving unit 11 specifies the bus from which the communication message is input and correlates the specified bus with the received communication message. The message receiving unit 11 outputs the received (input) communication message to the identifier checking unit 12.

The identifier checking unit 12 receives the communication message from the message receiving unit 11. The identifier checking unit 12 checks whether the identifier of the received communication message is the “regular ID” or the “relay ID” by comparison with the “normal ID information” and the “relay ID information”. The identifier checking unit 12 outputs the communication message of which the identifier is checked to be the “regular ID” to the message transmitting unit 15, and outputs the communication message of which the identifier is checked to the “relay ID” to the check unit 13. Specifically, the identifier checking unit 12 determines that the received communication message is a communication message with a “regular ID” when it is checked that the message ID acquired from the received communication message is set as a “regular ID” in the “regular ID information”. The identifier checking unit 12 determines that the received communication message is a communication message with a “relay ID” when it is checked that the message ID acquired from the received communication message is set as a “relay ID” in the “relay ID information”.

That is, the identifier checking unit 12 determines the relay of the communication message with a “regular ID” to be the “normal relay” and determines the relay of the communication message with a “relay ID” to be the “universal relay”.

The identifier checking unit 12 specifies a bus of a transmission destination on the basis of the “regular ID information” or the “relay ID information” in which the message ID acquired from the received communication message is set, and correlates the specified bus with the communication message. The correlation is performed by setting bus information in an address area secured in the storage unit or the like so as to set the transmission destination. The identifier checking unit 12 specifies a bus of a transmission source on the basis of the “relay ID information” in which the message ID acquired from the received communication message is set, and correlates the specified bus with the communication message. The correlation is performed by setting bus information in an address area secured in the storage unit or the like so as to set the transmission source.

A communication message with a “relay ID”, that is, a communication message to be subjected to the “universal relay”, is input to the check unit 13 from the identifier checking unit 12. The check unit 13 checks the correctness of the input communication message with the “relay ID” for the purpose of security securement or the like. The check unit 13 outputs the communication message with the “relay ID” that is checked to be correct to the identifier switching unit 14 and stops the relay of the communication message with the “relay ID” that is not checked to be correct.

Specifically, the check unit 13 checks whether the bus from which the communication message is input is equal to the bus as the transmission source specified on the basis of the “relay ID information”, relays the communication message when both buses are equal to each other, and stops the relay of the communication message when both buses are not equal to each other. Accordingly, it is possible to suppress unauthorized use of the “relay ID” by a device connected to another bus or the like.

The communication message with the “relay ID” that is checked, to be correct by the check unit 13 is input to the identifier switching unit 14. The identifier switching unit 14 generates a new communication message corresponding to the input communication message with the “relay ID”. The identifier switching unit 14 outputs the generated new communication message to the message transmitting unit 15.

The identifier switching unit 14 acquires “relay data DT11” stored in the data area of the input communication message with the “relay ID”. The identifier switching unit 14 generates a new communication message M2 on the basis of the “regular ID”, the “DLC”, and the “regular data” included in the acquired “relay data DT11”. The identifier switching unit 14 outputs the generated new communication message M2 to the message transmitting unit 15.

Specifically, the identifier switching unit 14 acquires the “regular ID” of 11 bits, the “DLC” of 3 bits, and the “regular data” of 0 to 50 bits from the acquired “relay data DT11”. For example, the identifier switching unit 14 acquires 11 bits as the “regular ID” from the head of the “relay data DT11” and acquires 3 bits subsequent thereto as the “DLC”. In the “DLC”, the length of the “regular data” subsequent thereto is set to a value of 0 to 6 [bytes] (0 to 48 bits). The identifier switching unit 14 acquires data with the length set in the “DLC” as the “regular data” from the head of the other bits of the “relay data DT11”. A value of 7 or 8 [byte] (56 or 64 bits) or greater may be set for the “DLC”. In this case, by acquiring 50 bits and the remaining bits to “0” or the like, the area of “regular data” of the “relay data DT11” can be utilized up to the 50-th bit.

Subsequently, as illustrated in FIG. 4, the identifier switching unit 14 generates a new communication message M2. The identifier switching unit 14 sets the “regular ID” acquired from the “relay data DT11” to the “identifier area” of the new communication message M2 and sets the value of 4 bits in which “0” is added to the upper bit of the “DLC” acquired from the relay data DT11” is set as the “DLC” of the new communication message M2. The identifier switching unit 14 stores the “regular data” of the relay data DT11” in the “data area” of the new communication message M2. The identifier switching unit 14 may set insufficient bits to “0” when the length of the “regular data” of the “relay data DT11” is smaller than the than length of the “regular data” set in the “DLC”. Accordingly, the new communication message M2 including the “regular ID” of 11 bits, the “DLC” of 4 bits, and the “regular data” of 0 to 64 bits is generated.

The communication message of which the identifier is checked to a “regular. ID” is input to the message transmitting unit 15 from the identifier checking unit 12 and the new communication message M2 is input thereto from the identifier switching unit 14. The message transmitting unit 15 specifies the bus to which the input communication message is transmitted on the basis of an address to which a bus of a transmission destination is set or the like and transmits the input communication message to the specified bus. Accordingly, for example, the communication message with the “regular ID” transmitted from the 21-st ECU 21 and input to the GW 10 via the first bus 20 is output to the second bus 30 or the third bus 40 specified on the basis of the “regular ID” and is received by the 31-st to 42-nd ECU 31 to 42. The new communication message M2 corresponding to the communication message M1 with the “relay ID” transmitted from the 21-st ECU 21 and input to the GW 10 via the first bus 20 is output to the third bus 40 specified on the basis of the “relay ID” and is received by the 42-nd ECU 42 connected to the bus.

The operation of this embodiment, that is, the processing operation of the relaying process in the GW 10, will be described below with reference to a flowchart. In the GW 10, the process flow of the relaying process is started in response to an input of a communication message from a bus.

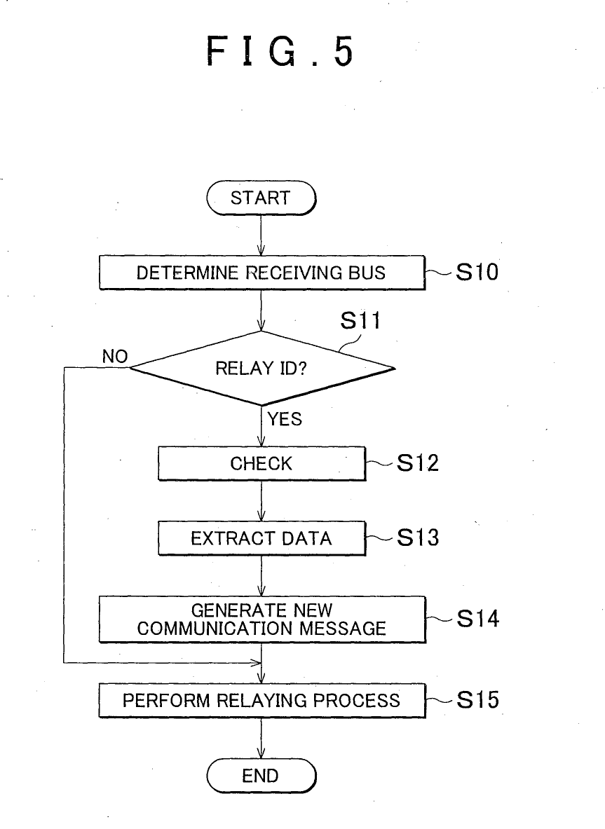

As illustrated in FIG. 5, when the process flow of the relaying process is started, the GW 10 specifies (determines) the bus from which the communication message is received (step S10) and determines whether the message ID of the received communication message is a “relay ID” (step S11). When the message ID is a “relay ID”, it is determined that the message ID is included in the “relay ID information”. At this time, a bus as a transmission destination of the communication message is specified from the “relay ID information” on the basis of the “relay ID”. It may be determined whether the message ID is a “regular ID” by comparison with the “regular ID information” and the bus as the transmission destination of the communication message may be specified from the “regular ID information” on the basis of the “regular ID”.

When it is determined that the message ID of the received communication message is not a “relay ID” (NO in step S11), the GW 10 performs a process of relaying the communication message (step S15). Then, the GW 10 transmits, that is, relays, the received (input) communication message to the specified bus as the transmission destination. Then, the process flow of the relaying process ends by transmitting the communication message to the specified bus.

On the other hand, when it is determined that the message ID of the received (input) communication message is a “relay ID” (YES in step S11), the GW 10 checks whether the bus as the transmission source of the communication message is equal to the bus as the transmission source acquired from the “relay ID” and the “relay ID information” (step S12). The GW 10 acquires the “relay data” from the “data area” of the communication message (step S13). Then, the GW 10 generates a new communication message M2 on the basis of the acquired “relay data” (step S14). That is, in the new communication message M2, the “regular ID” of the “relay data” is set in the “identifier area”, the “DLC” of the “relay data” is adjusted to 4 bits and set in the “DCL”, and the “regular data” of the relay data” is adjusted to 0 to 8 bytes (0 to 64 bits) and set in the “data area”.

Then, the GW 10 transmits, that is, relays, the generated new communication message M2 to the specified bus as the transmission destination (step S15). The process flow of the relaying process ends by transmitting the communication message to the specified bus.

As described above, in the communication system according to this embodiment, it is possible to enhance universality as a network including a gateway. As described above, the communication system according to this embodiment achieves the following advantages.

(1) A bus used for transmission is specified by the gateway 10 regardless of the type of the “regular data” as user data. Accordingly, it is possible to enhance the universality in transmission of a communication message in a communication system. In case of the CAN that is often used for a vehicle network system, since a “regular ID” as an identifier is determined depending on the type of the user data, it is necessary to set a bus as a transmission destination depending on the type of the user data, but the bus as the transmission destination is specified regardless of the type of the user data by using a “relay ID”.

(2) In the gateway 10, since the bus as a transmission destination corresponding to the “relay ID” is set by the “relay ID information”, the bus as the transmission destination of a communication message can be specified regardless of the type of the user data.

(3) A communication message with a “relay ID” is generated as a communication message with a “regular ID” corresponding to user data in the “identifier area” and the generated communication message is transmitted to the bus specified by the “relay ID”. Accordingly, a communication message with a “relay ID” and transmitted to the gateway 10 is transmitted as a communication message in the related art from the gateway 10 to the bus.

(4) A communication message with a “relay ID” is relayed by the gateway 10 regardless of the type of the user data. Accordingly, it is possible to suppress incorrect use of the “relay ID” and to improve security of the communication system, by checking the bus as a transmission source of the communication message with the “relay ID” on the basis of the relay identifier.

### Second Embodiment

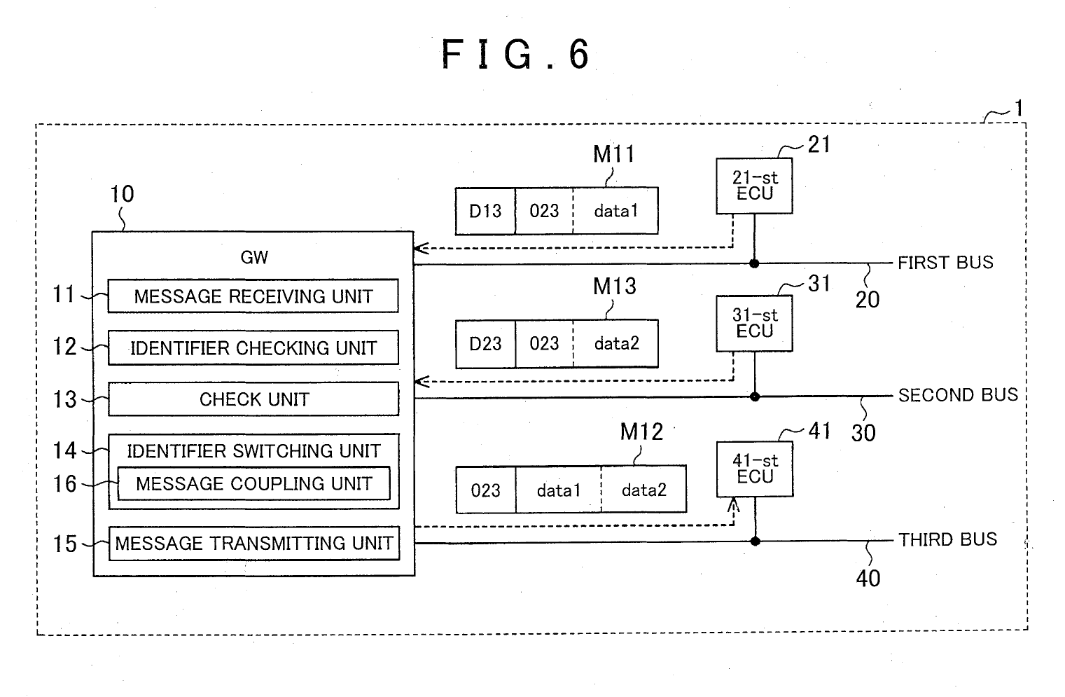

A communication system according to a second embodiment of the invention will be described below with reference to FIGS. 6 to 8. This embodiment is different from the first embodiment, in that it has a configuration in which one new communication message is generated from two communication messages with “relay IDs”, but both embodiments are equal to each other in the other configuration. Accordingly, the configuration different from the first embodiment will be mainly described below, the same elements as in the first embodiment will be referenced by the same reference signs, and detailed description thereof will not be repeated for the purpose of convenience of explanation.

As illustrated in FIG. 6, a communication message M11 with a “relay ID” is transmitted from the 21-st ECU 21 to the first bus 20 and the transmitted communication message M11 is input to the GW 10. A communication message M13 with a “relay ID” is transmitted from the 31-st ECU 31 to the second bus 30 and the transmitted communication message M13 is input to the GW 10.

In the communication message M11 with the “relay ID” transmitted from the 21-st ECU 21, “D13” is stored in the “identifier area” and “relay data” is stored in the “data area”. The “relay data” includes “023” as a “regular ID” and includes “data1” as “regular data”.

In the communication message M13 with the “relay ID” transmitted from the 31-st ECU 31, “D23” is stored in the “identifier area” and “relay data” is stored in the “data area”. The “relay data” includes “023” as a “regular ID” and includes “data2” as “regular data”.

The GW 10 includes a message receiving unit 11, an identifier checking unit 12, a message transmitting unit 15, a check unit 13, and an identifier switching unit 14. In this embodiment, the identifier switching unit 14 includes a message coupling unit 16. The message coupling unit 16 couples two pieces of “regular data” of two communication messages with the “relay IDs” added thereto and generates a new communication message including the coupled “regular data”. In the message coupling unit 16, information for determining whether the communication messages input to the identifier switching unit 14 are to be coupled on the basis of the “regular IDs” of the “relay data”. Accordingly, the identifier switching unit 14 causes the message coupling unit 16 to determine whether the input communication messages are to be coupled. The identifier switching unit 14 generates a new communication message from the “relay data” of one communication message of the communication messages are determined not to be coupled and outputs the generated communication message to the message transmitting unit 15.

On the other hand, in the identifier switching unit 14, regarding a communication message determined to be coupled, when the communication message and another communication message to be coupled to the communication message are input, the message coupling unit 16 couples the communication messages. The identifier switching unit 14 causes the message coupling unit 16 to generate a new communication message from the two input communication message and to output the generated communication message to the message transmitting unit 15.

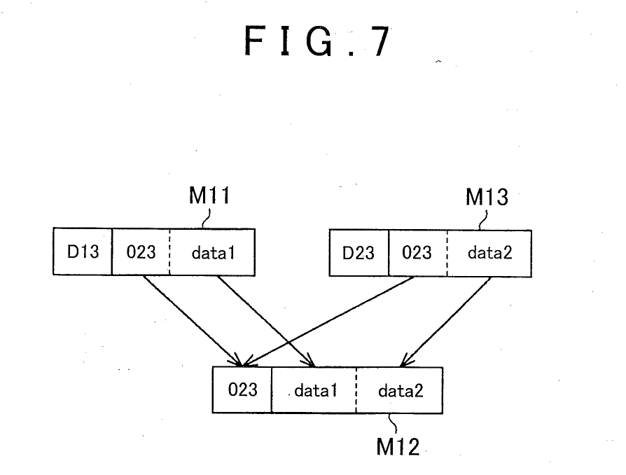

As illustrated in FIG. 7, the message coupling unit 16 determines whether the buses as transmission destinations specified by the “relay IDs” of the two input communication messages are equal to each other. When the buses as the transmission destinations are not equal to each other, the message coupling unit 16 determines that the two communication messages are not to be coupled. On the other hand, when the buses as the transmission destinations specified by, the “relay IDs” of the two communication messages are equal to each other, the message coupling unit 16 acquires “regular IDs” and “regular data” from the “relay data” of the two communication messages. The message coupling unit 16 determines whether the acquired two “regular IDs” are equal to each other. When the two “regular IDs” are not equal to each other, the message coupling unit 16 determines that the two communication messages are not to be coupled. On the other hand, when the two “regular IDs” are equal to each other, the message coupling unit 16 stores the “regular ID” in the “identifier area” of a new communication message M12. The acquired two pieces of “regular data” are coupled using a predetermined rule. The two pieces of “regular data” to be coupled preferably have a length of 64 bits or less by coupling, but even when the two pieces of “regular data” have a length greater than 64 bits by coupling, the coupled regular data can be divided and transmitted.

For example, as illustrated in FIG. 7, the message coupling unit 16 receives a communication message M11 from the first bus 20 and a communication message M13 from the second bus 30. The message coupling unit 16 specifies a bus as a transmission destination to be the third bus 40 on the basis of the “relay ID” and the relay ID information 121 of the communication message M11, and specifies a bus as a transmission destination to be the third bus 40 on the basis of the “relay ID” and the relay ID information 121 of the communication message M13. Accordingly, the message coupling unit 16 determines that the buses of the transmission destinations specified by the “relay IDs” are equal to each other. Subsequently, the message coupling unit 16 acquires “023” as the “regular ID” and “data1” as the “regular data” from the “relay data” of the communication message M11. The message coupling unit 16 acquires “023” as the “regular ID” and “data2” as the “regular data” from the “relay data” of the communication message M13. Subsequently, the message coupling unit 16 determines that the “regular ID” acquired from the “relay data” of the communication message M11 and the “regular ID” acquired from the “relay data” of the communication message M13 are “023” and are equal to each other. The message coupling unit 16 determines whether “023” as the “regular ID” is to be coupled. When it is determined that “023” is included in the setting of the “regular ID” to be coupled, the message coupling unit 16 generates new “regular data” by coupling “data1” acquired from the “relay data” of the communication message M11 and “data2” acquired from the “relay data” of the communication message M13. For example, the message coupling unit 16 may generate the new “regular data” so that “data2” is arranged subsequent to “data1”, or may generated the new “regular data” so that the “data area” are divided into two areas, “data1” is stored in one area, and “data2” is stored in the other area.

The message coupling unit 16 generates a new communication message M12 in which “023” is stored in the “identifier area” and the “regular data” in which “data1” and “data2” are coupled is stored in the “data area”. That is, a new communication message M12 is generated on the basis of the communication message M11 from the first bus 20 and the communication message M13 from the second bus 30.

The message coupling unit 16 outputs the new communication message M12, which has been generated in this way, to the message transmitting unit 15. Accordingly, the message transmitting unit 15 transmits the new communication message M12 input froth the message coupling unit 16 to the specified bus as the transmission destination, for example, the third bus 40.

In the 41-st ECU 41 connected to the third bus 40, at least one rule of the coupling rules of the new “regular data” generated by the message coupling unit 16 is set. Accordingly, even when a new communication message M12 transmitted from the GW 10 is received, the 41-st ECU 41 determines that two pieces of “regular data” are included in the “data area” of the communication message M12 and acquires two pieces of “regular data”, for example, “data1” and “data2”, therefrom.

Accordingly, since the amount of a communication message transmitted to the bus can be reduced, it is possible to reduce a communication load of the bus. A process flow of a relaying process in the GW 10 will be described below with reference to a flowchart. In the GW 10, the process flow of the relaying process is started in response to an input of a communication message from a bus.

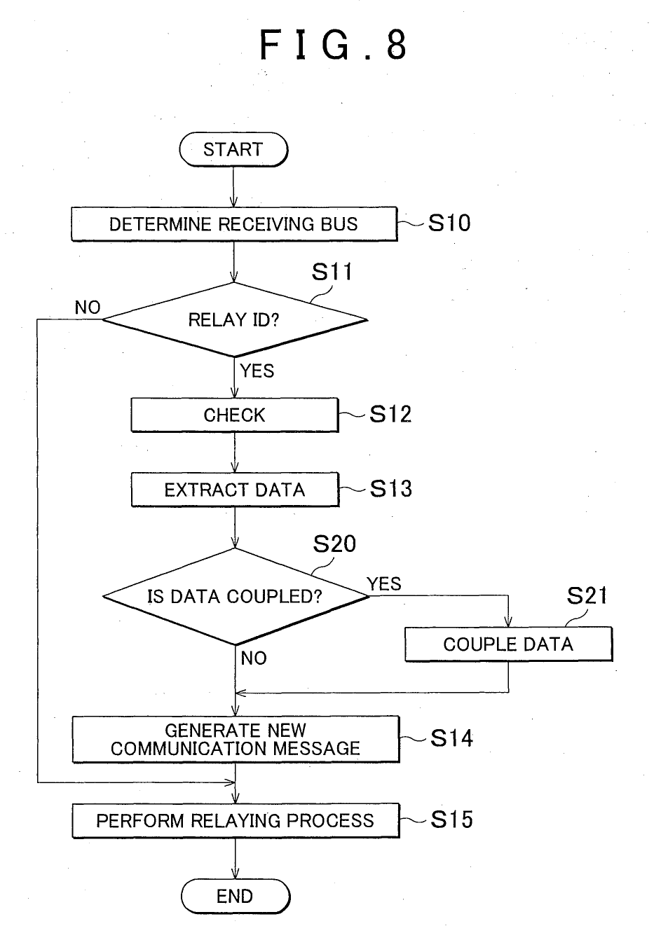

As illustrated in FIG. 8, when the process flow of the relaying process is started, the GW 10 specifies (determines) the bus from which the communication message is received (step S10), and determines whether the message ID of the received communication message is a “relay ID” (step S11). The bus as a transmission destination of the communication message is specified from the “relay ID information” on the basis of the “relay ID”. In addition, it may be determined whether the message ID is a “regular ID” by comparison with the “regular ID information”, and the bus as a transmission destination of the communication message may be specified from the “regular ID information” on the basis of the “regular ID”.

When it is determined that the message ID of the received communication message is not a “relay ID” (NO in step S11), the GW 10 performs a process of relaying the communication message (step S15). Then, the GW 10 transmits, that is, relays, the received (input) communication message to the specified bus as the transmission destination. The process flow of the relaying process ends by transmitting the communication message to the specified bus.

On the other hand, when the message ID of the received (input) communication message is a “relay ID” (YES in step S11), the GW 10 checks whether the bus as the transmission source of the communication message and the bus as the transmission source specified from the “relay ID” and the “relay ID information” (step S12). The GW 10 acquires the “relay data” from the “data area” of the communication message (step S13). The GW 10 determines whether two communication messages are to be coupled on the basis of the “regular ID” of the acquired “relay data” (step S20).

When it is determined that the two communication messages are to be coupled (YES in step S20), the GW 10 acquires a second communication message corresponding to the input communication message and sets data, which is generated by coupling the “regular data” of the “relay data” of the two communication messages, as new “regular data” (step S21). The GW 10 calculates an appropriate “DLC”, sets the calculated “DLC” as a new “DLC”, and sets the “regular ID” of the “relay data” as a new “regular ID” (step S21).

On the other hand, when it is determined that the two communication message are not to be coupled (NO in step S20), the GW 10 sets the “regular data” of the “relay data” of the input communication message as new “regular data”. The GW 10 sets the “DLC” of the “relay data” as a new “DLC” and sets the “regular ID” of the “relay data” as a new “regular ID”.

Then, the GW 10 generates a new communication message M12 (step S14). The GW 10 generates the new, communication message M12 in which the set new “regular ID” is stored in the “identifier area”, the set new “DLC” is stored in the “DLC”, and the set new “regular data” in the “data area”. That is, in the new communication message M12, the new “regular ID” is set in the “identifier area”, the new “DLC” is set in the “DLC”, and the new “regular data” is set in the “data area”.

The GW 10 transmits, that is, relays, the generated new communication message M12 to the bus as the transmission destination specified from the “relay ID” (step S15). The process flow of the relay process ends by transmitting the communication message to the specified bus.

As described above, the communication system according to this embodiment achieves the following advantage in addition to the advantages of (1) to (4) described in the first embodiment. (5) By coupling two communication messages into one communication message, it is possible to reduce an amount of communication messages transmitted in the communication system and to reduce a communication load of the communication system. Accordingly, the reliability, the stability, the security, and the like of the communication system can be suitably maintained.

### Third Embodiment

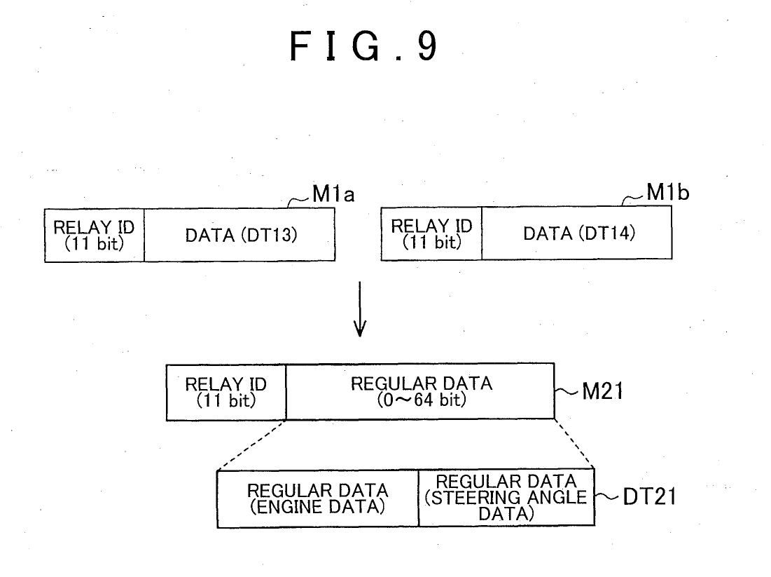

A communication system according to a third embodiment of the invention will be described below with reference to FIG. 9. This embodiment is different from the second embodiment, in that it has a configuration in which two communication messages with different types of regular data are coupled, but both embodiments are equal to each other in the other configuration. Accordingly, the configuration different from the second embodiment will be mainly described below, the same elements as in the second embodiment will be referenced by the same reference signs, and detailed description thereof will not be repeated for the purpose of convenience of explanation.

As illustrated in FIG. 9, a communication message M1a with a “relay ID” and a communication message M1b with a “relay ID” are input to the GW 10. The communication message M1a includes engine data as “regular data” of “relay data DT13”. The communication message M1b includes steering angle data as “regular data” of “relay data DT14”. That is, the “regular data” of the “relay data DT13” and the “regular data” of the “relay data DT14” are different from each other in the type of data.

The GW 10 is set to couple the “relay data DT13” with a “regular ID” corresponding to the engine data and the “relay data DT14” with a “regular ID” corresponding to the steering angle data and to transmit a new communication message. Specifically, in this embodiment, in the “regular ID” corresponding to the engine data included in the “relay data” and the “regular ID” corresponding to the steering angle data included in the “relay data”, the “regular data” included in the “relay data” is set to be coupled. In the GW 10, the “regular ID” to be added to the new communication message M21 generated in this way is also set.

The process of coupling two communication messages in the GW 10 will be described below. When a communication message with a “relay ID” is received, the GW 10 determines whether a “regular ID” in “relay data” of the communication message is set to couple data. When it is determined that the “regular ID” is not set to couple data, the GW 10 relays the communication message according to the aspect described in the first or second embodiment.

On the other hand, when it is determined that the “regular ID” is set to couple data, the GW 10 acquires two communication messages M1a, M1b including such a type of data to be coupled. When the two communication messages M1a, M1b including the type of data to be coupled are acquired, the GW 10 generates a new communication message M21 on the basis of the acquired two communication messages.

For example, when the communication message M1a or the communication message M1b is input, the GW 10 acquires “relay data DT13” from the communication message M1a or acquires “relay data DT14” from the communication message M1b. When the “regular ID” of the “relay data DT13” or the “regular ID” of the “relay data DT14” is set to couple data, the GW 10 waits for a predetermined time until a communication message including the other type of data to be coupled is input. When two types of “regular data” to be coupled are acquired, the GW 10 generates new “regular data DT21” in which the two types of “regular data” are coupled and acquires a new “regular ID” corresponding to the generated new “regular data DT21”. Then, the GW 10 generates a new communication message M21 in which the acquired new “regular ID” is stored in the “identifier area” and the new “regular data DT21” is stored in the “data area”. Then, the GW 10 outputs the new communication message M21 to the message transmitting unit 15. Accordingly, the message transmitting unit 15 transmits the new communication message M21 to a bus as a transmission destination specified from the “relay ID”.

As described above, the communication system according to this embodiment achieves the following advantage in addition to the advantages of (1) to (5) described in the first and second embodiments. (6) Since two communication messages having different types of “regular data” can be coupled, it is possible to enhance the possibility of reducing an amount of communication messages and to further reduce a communication load of the communication system.

### Fourth Embodiment

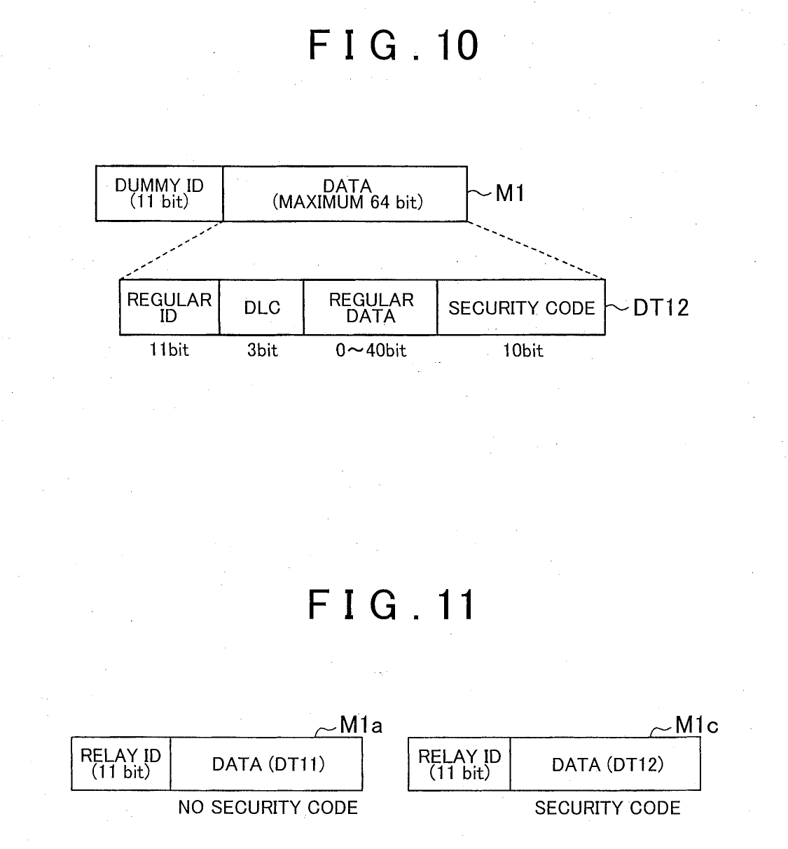

A communication system according to a fourth embodiment of the invention will be described below with reference to FIG. 10. This embodiment is different from the first embodiment, in that a security code is included in “relay data” of a communication message transmitted from an ECU, but both embodiments are equal to each other in the other configuration. Accordingly, the configuration different from the first embodiment will be mainly described below, the same elements as in the first embodiment will be referenced by the same reference signs, and detailed description thereof will not be repeated for the purpose of convenience of explanation.

As illustrated in FIG. 10, a communication message M1 is input to the GW 10. “Relay data DT12” is stored in the data area of the communication message M1. The “relay data DT12” includes a “regular ID” of 11 bits, a “DLC” of 3 bits, “regular data” of 0 to 40 bits, and a “security code” as security information of 10 bits. The “security code” is a code for causing the GW 10 to determine correctness of an ECU having transmitted the communication message M1, and the correctness of the “security code” is verified, for example, by the check unit 13 or the identifier switching unit 14 of the GW 10. The “security code” is constituted by a code or the like calculated on the basis of a rule determined in advance by the GW 10 and ECUs and a known method capable of improving security even if only a little is used. Examples of the code calculating method include methods using a predetermined function, table, map, or private key and methods using public keys and private keys.

That is, the ECU having transmitted the communication message M1 generates a “security code” of 10 bits on the basis of the cooperative determination with the GW 10 and sets the generated “security code” in the “relay data”. The ECU transmits the communication message M1 in which the “relay ID” is stored in the “identifier area” and the “relay data” including the “security code” is stored in the “data area” to the GW 10 via a bus connected thereto.

When the input communication message M1 includes a “relay ID”, the GW 10 acquires the “security code” from the “relay data” of the communication message M1 and determines the correctness of the acquired “security code”. For example, when a value obtained by decoding the “security code” or the like is equal to a predetermined appropriate value, the GW 10 determines that the “security code” is correct. The GW 10 relays the communication message M1 when it is determined that the “security code” is correct, and stops relaying of the communication message M1 when it is determined that the “security code” is not correct. Accordingly, it is possible to improve the security in relaying of the communication message M1 with the “relay ID” set therein.

The GW 10 may not store the “security code” in the “data area” of a new communication message M2 to correspond to the communication message M1 with the “relay ID” set therein.

As described above, the communication system according to this embodiment achieves the following advantage in addition to the advantages of (1) to (4) described in the first embodiment. (7) By checking correctness of a communication message using a “security code”, it is possible to improve security in communications using a communication message with a “relay ID” relayed by the gateway 10 regardless of the type of user data. A known technique such as encryption using a private key can be used as the “security code”.

### Other Embodiments

The above-mentioned embodiments may be embodied in the following aspects. The second and third embodiments have described an example where communication messages not including a “security code” are coupled. However, the invention is not limited to this example, but communication messages including a “security code” may be coupled. A communication message not including a “security code” and a communication message including a “security code” may be coupled.

For example, as illustrated in FIG. 11, a communication message M1a including a “relay ID” and not including a “security code” and a communication message M1c including a “relay ID” and including a “security code” may be coupled.

Accordingly, it is possible to improve a degree of freedom in design of the communication system. The second embodiment has described an example where equality of buses as transmission destinations which are specified by the “relay IDs” of two communication messages is used to determine whether the communication messages are to be coupled. However, the invention is not limited to this example, but the equality of the buses as transmission destinations which are specified by the “relay IDs” of two communication messages may not be used to determine whether the communication messages are to be coupled. In this case, when a transmission destination of a newly-set “regular ID” is determined, the communication messages may be transmitted to an appropriate bus from the GW. Accordingly, it is possible to improve a degree of freedom in design of the communication system.

The second embodiment has described an example where a single piece of “regular data” to be stored in a new communication message is generated from two pieces of “regular data” of two communication messages with “relay IDs” added thereto. However, the invention is not limited to this example, but a single piece of “regular data” may be generated from two or more pieces of “regular data”. The generated single piece of “regular data” preferably has a length of 64 bits or less, but may have a length more than 64 bits. When the regular data has a length more than 64 bits, the “regular data” may be divided and transmitted, and the utilization efficiency of the data area may be enhanced by the division and transmission. Accordingly, it is possible to improve a degree of freedom in design of the communication system.

The above-mentioned embodiments have described an example where total three buses of the first to third buses 20, 30, and 40 are connected to the GW 10. However, the invention is not limited to this example, but the number of buses connected to the GW may be two or more, two or less, or four or more. Accordingly, it is possible to enhance applicability of the communication system.

The above-mentioned embodiments described an example where the number of ECUs connected to each of the first to third buses 20, 30, and 40 is one or two However, the invention is not limited to this example, but the number of ECUs connected to each bus only has to be a number suitable for the standard of the CAN protocol and may be one, two, or three or more. Accordingly, it is possible to improve a degree of freedom in configuration of the communication system.

The above-mentioned embodiments have described an example where a communication message M1 with a “relay ID” is output from the 21-st ECU 21. However, the invention is not limited to this example, but a communication message with a “relay ID” may be output from other ECUs. The above-mentioned embodiments have described an example where a new communication message M2 is received by the 41-st and 42-nd ECUs 41, 42. However, the invention is not limited to this example, but the ECU capable of receiving a new communication message is not particularly limited. Accordingly, it is possible to improve a degree of freedom in configuration of the communication system and to enhance applicability thereof.

The above-mentioned embodiments have described an example where the GW 10 includes the message receiving unit 11, an identifier checking unit 12, a check unit 13, an identifier switching unit 14, and the message transmitting unit 15. However, the invention is not limited to this example, but the GW may have any configuration as long as the functions of the message receiving unit, the identifier checking unit, the check unit, the identifier switching unit, and the message transmitting unit are exhibited. For example, the functional units may be constituted as a single information processing unit or may be divided into more functional units. Accordingly, it is possible to improve a degree of freedom in design of the communication system.

The fourth embodiment has described an example where the “security code” included in the “relay data DT12” has a length of 10 bits. However, the invention is not limited to this example, but the “security code” may have a length less than 10 bits or may have a length greater than 10 bits. The number of bits may be increased when it is wanted to enhance the “security code” level, and the number of bits may be decreased when it is wanted to enhance the number of bits allocated to the “regular data”. Accordingly, it is possible to improve a degree of freedom in design of the communication system.

The above-mentioned embodiments have described an example where the check unit 13 checks the correctness of a communication message with a “relay ID”. However, the invention is not limited to this example, but the check unit may check the correctness of a communication message with a “regular ID”. For example, by setting information on a bus as a transmission source in the “regular ID information”, it is possible to check equality of a bus (bus as a transmission source) from which a communication message and a bus as a transmission source set by the “regular ID information”. In this case, only a communication message with a “regular ID” determined to be correct by the check unit only has to be output to the message transmitting unit. Accordingly, it is possible to further improve security of the communication system.

The above-mentioned embodiments have described an example where the check unit 13 is provided. However, the invention is not limited to this example, but the check unit may not be provided. Accordingly, it is possible to improve a degree of freedom in design of the communication system.

The above-mentioned embodiments have described an example where the GW 10 does not relay a communication message with a message ID not set in the “regular ID information” or the “relay ID information”. However, the invention is not limited to this example, but the GW may relay a communication message with a message ID not set in the “regular ID information” or the “relay ID information”. Accordingly, since only the message ID of a communication message of which the relaying is inhibited only has to be set in the “regular ID information” or the “relay ID information”, it is possible to easily manage the GW.

The above-mentioned embodiments have described an example where the data frame has a standard format. However, the invention is not limited to this example, but the data frame may have an extension format. Accordingly, it is possible to improve a degree of freedom in design of the communication system.

The above-mentioned embodiments have described an example where the communication system is a system based on the CAN protocol. However, the invention is not limited to this example, but the communication protocol applied to the communication system may be a protocol other than the CAN protocol, for example, a communication protocol such as Ethernet (registered trademark) FlexRay (registered trademark), as long as the GW can relay a communication message among plural buses. Particularly, a communication protocol in which a transmission destination is not specified from a communication identifier can be suitably used. Accordingly, it is possible to enlarge applicability of the communication system.

The above-mentioned embodiments have described an example where the vehicle 1 is an automobile. However, the invention is not limited to this example, but the communication system may be provided to a moving object other than an automobile, such as a ship, a railway, an industrial machine, or a robot.

1. A communication system comprising:
a communication device that is connected to a communication line and that performs communication via the connected communication line using a communication message including a data area in which data is stored and an identifier area in which a communication identifier determined to correspond to the data is stored; and
a gateway that is connected to a plurality of the communication lines and that relays a communication message among the plurality of communication lines,
wherein the communication device transmits a communication message, in which user data and a communication identifier corresponding to the user data are stored in the data area and a relay identifier for allowing the gateway to specify a communication line through which the user data stored in the data area is transmitted in the identifier area, to the gateway.

2. The communication system according to claim 1, wherein the gateway has information of the relay identifier and a communication line as a transmission destination corresponding to the relay identifier and the gateway specifies the communication line as the transmission destination of a communication message from which the relay identifier is acquired on the basis of the relay identifier acquired from the identifier area of the received communication message.

3. The communication system according to claim 2, wherein the gateway generates a communication message in which a communication identifier stored in the data area of the communication message having the relay identifier is stored in the identifier area and user data stored in the communication message is stored in the data area, and transmits the generated communication message to the specified communication line.

4. The communication system according to claim 1, wherein the communication line as a transmission source corresponding to the relay identifier is set in the gateway and the gateway performs a process of relaying the communication message when the communication line as the transmission source of the communication message is equal to the communication line as the transmission source corresponding to the relay identifier in the identifier area of the communication message.

5. The communication system according to claim 1, wherein the communication device transmitting the communication message adds security information used for proof of correctness of the communication message to the data area and transmits the communication message, and the gateway performs the process of relaying the communication message when it is determined that the communication message is correct on the basis of the security information.

6. A communication method in a communication system including a communication device that is connected to a communication line and that performs communication via the connected communication line using a communication message including a data area in which data is stored and an identifier area in which a communication identifier determined to correspond to the data is stored and a gateway that is connected to a plurality of the communication lines and that relays a communication message among the plurality of communication lines, the communication method comprising:
causing the communication device to store user data and a communication identifier corresponding to the user data in the data area of the communication message;
causing the communication device to store a relay identifier for allowing the gateway to specify the communication line through which the user data stored in the data area is transmitted in the identifier area of the communication message; and
causing the communication device to transmit the generated communication message to the gateway.

7. The communication method according to claim 6, wherein the gateway specifies the communication line as a transmission destination of the communication message from which the relay identifier is acquired on the basis of the relay identifier acquired from the identifier area of the communication message by presetting the communication line as the transmission destination corresponding to the relay identifier.
